(19) United States
(12) Patent Application Publication
(10) Pub. No.: US 2025/0389562 A1
(43) Pub. Date: Dec. 25, 2025

(54) Method and Apparatus for Calibrating a Parameter of a Vehicle Sensor

(71) Applicant: Robert Bosch GmbH, Stuttgart (DE)

(72) Inventor: Simon Weissenmayer, Flein (DE)

(21) Appl. No.: 19/241,966

(22) Filed: Jun. 18, 2025

(30) Foreign Application Priority Data
Jun. 19, 2024 (DE) 10 2024 205 655.3

(51) Int. Cl. G01D 18/00

(52) U.S. Cl. CPC G01D 18/008

(57) ABSTRACT

A method for calibrating a parameter of a measurand sensor of a vehicle includes (i) providing at least one historical sensor state value series with an associated variance in a storage medium in relation to at least one historical driving maneuver of the vehicle, (ii) reading at least one sensor state value series detected by the at least one measurand sensor regarding a driving maneuver of the vehicle, (iii) calculating a variance from the at least one detected sensor state value series, (iv) comparing the variance of the at least one historical sensor state value series to the calculated variance of the at least one detected sensor state value series, (v) overwriting the at least one historical sensor state value series with the detected sensor state value series when the variance of the detected sensor state value series is greater than the variance of the at least one historical sensor state value series, and (vi) calibrating the parameter of the measurand sensor by maximizing a probability function, in particular a marginal likelihood function, based at least on the detected sensor state value series overwriting the historical sensor state value series.

This application claims priority under 35 U.S.C. § 119 to application no. DE 10 2024 205 655.3, filed on Jun. 19, 2024 in Germany, the disclosure of which is incorporated herein by reference in its entirety.

The disclosure relates to a method and an apparatus for calibrating a parameter of a vehicle sensor of a vehicle.

### BACKGROUND

The precise alignment of sensors in vehicles plays a key role in the accuracy and reliability of the data collected. However, due to tolerances that may occur in the assembly of bolted connections and/or soldered connections, the exact orientation of the sensors in the vehicle coordinate system is often unclear. These tolerances may cause the orientations of the sensors to vary by up to +1° between different vehicles. Such differences in sensor orientation can impact the accuracy of the sensor fusion and the applications based thereon, such as driver assistance systems and autonomous driving systems.

For example, a method for calibrating a slope sensor of a vehicle transmission is known from DE 10 2010 041 968 A1. For example, a control unit, a method, and a sensor assembly for self-monitored locating are known from DE 10 2018 218 492 A1.

In order to overcome the aforementioned challenges, it is necessary to develop a system that is capable of learning and correcting the differences in orientation of the sensors during vehicle operation. It is important that the computing power required for this is reduced to a minimum so as not to impair the efficiency and performance of the overall system. Minimizing computing power is particularly relevant for embedded systems in the vehicle, which typically have limited computing resources.

It is therefore a problem addressed by the disclosure to provide an improved method and/or apparatus.

The problem is solved by a method according to the features set forth below. The problem is solved by an apparatus according to the features also set forth below.

### SUMMARY

According to a first aspect, a method for calibrating a parameter of a measured value sensor of a vehicle is proposed. The method comprises the steps of:
providing at least one historical sensor state value series with an associated variance in a storage medium in relation to at least one historical driving maneuver of the vehicle;
reading at least one sensor state value series detected by the at least one measurand sensor regarding a driving maneuver of the vehicle;
calculating a variance from the at least one detected sensor state value series;
comparing the variance of the at least one historical sensor state value series to the calculated variance of the at least one detected sensor state value series;
overwriting the at least one historical sensor state value series with the detected sensor state value series when the variance of the detected sensor state value series is greater than the variance of the at least one historical sensor state value series; and
calibrating the parameter of the measurand sensor by maximizing a probability function, in particular a marginal likelihood function, based at least on the detected sensor state value series overwriting the historical sensor state value series.

That is to say, in other words, in the overwriting step, the detected sensor state value series is stored in the storage medium in order to replace or overwrite the historical sensor state value series with the detected sensor state value series. In this case, overwriting or replacing the at least one historical sensor state value series with the detected sensor state value series can comprise a step of deleting the historical sensor state value series and a step of storing the detected sensor state value series. Thus, the calibration occurs at least based on the detected sensor state value series previously stored in the storage medium.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, an apparatus for calibrating a parameter of a measurand sensor of a vehicle is proposed. The apparatus comprises a storage medium, at least one measurand sensor, and at least one evaluation-and-calculation unit. The storage medium is configured so as to provide at least one historical sensor state value series with an associated variance in relation to at least one historic driving maneuver of the vehicle. The at least one measurand sensor is configured so as to detect at least one sensor state value series regarding a travel maneuver of the vehicle.

The evaluation-and-calculation device is configured so as to calculate a variance to the at least one detected sensor state value series, compare the variance of the at least one historical sensor state value series to the calculated variance of the at least one detected sensor state value series, and overwrite the at least one historical sensor state value series with the detected sensor state value series in the storage medium when the variance of the detected sensor state value series is greater than the variance of the at least one historical sensor state value series, and to calibrate the parameter of the measurand sensor by maximizing a probability function, in particular a marginal likelihood function, at least on the basis of the detected sensor state value series overwriting the historical sensor state value series.

The explanations given for the method apply to the apparatus accordingly. In this regard, any linguistic modifications of features formulated in terms of the method can be reformulated for the device in accordance with standard linguistic practice, without such formulations having to be explicitly listed here.

By implementing such a system, the accuracy and reliability of vehicle-based sensor systems can be significantly improved. This not only contributes to the safety and efficiency of the vehicle, but also forms a basis for driver assistance systems and/or other vehicle technologies.

In the present case, particularly suitable driving maneuvers, namely those in which the detected sensor-state time series have a large variance, are recorded at least temporarily in the storage medium, and in particular after stopping the vehicle or during ongoing operation, are considered for the calibration of the at least one parameter of the measured-value sensor or vehicle sensor in order to calibrate the at least one parameter of the at least one measurand sensor. The at least one measurand sensor can preferably be an optical sensor, for example a camera and/or a LIDAR sensor and/or a radar sensor and/or an ultrasonic sensor.

The data required for the calibration of the at least one parameter of the at least one measurand sensor or parameters from the detected sensor time series are preferably used in the following trips or driving maneuvers of the vehicle, for example, in order to improve the accuracy of a calculation of a vehicle speed and/or a pose of the vehicle to be carried out based on the at least one vehicle sensor. The historical sensor state value series were also preferably detected by the at least one measurand sensor in past driving maneuvers. The sensor state value series preferably represent sensor measurands that are detected by the at least one measurand sensor.

The sensor measurands of a current driving maneuver of the vehicle are thus preferably written into the storage medium, for example a ring buffer, and a variance is calculated for each state value series. In addition, there preferably exists a (further) storage medium in which the historical sensor status value series are stored for a driving maneuver from the past, which is used for the parameter optimization or parameter calibration. If a variance of the detected state value series of a current driving maneuver is now greater than the variance of the preferably sensor-type or driving-type state value series from the past, the historical driving maneuver is overwritten in the storage medium. Ideally, the storage medium for storing driving maneuvers from the past is large enough that more than one driving maneuver can be recorded or stored. Thus, driving maneuvers can preferably be maintained in the storage medium, where the variances of different Kalman filter state rows are each maximal in order to make the calibration even more accurate.

If the optimization or calibration of the parameter is completed, it is preferably performed again only if there are new recordings by the measurand sensor. When the vehicle is put into service, driving maneuvers can preferably be driven in a targeted manner where the variance in the Kalman filter state rows is particularly large.

If the variances of multiple relevant Kalman filter state series exceed at least one minimum threshold, it can be preferable to disable the recording of new driving maneuvers.

In the case of mechanical changes to the measurand sensor, for example after loosening of a bolt connection of the measurand sensor and/or exchanging the measurand sensor, the learned parameter calibration values and the detected and/or stored sensor state value series regarding travel maneuvers are no longer useful, so that the method is preferably reinitialized. The initialization can occur, for example, with the aid of a vehicle tester and/or via user input via an interface of the vehicle.

Compared to the modeling of the installation position differences as a Kalman filter condition, the method has the advantage that the computing load is lower during the journey. In addition, the method and apparatus can conserve costs in acquisition and energy costs during operation of the vehicle.

In a further aspect, it is proposed that the at least one sensor state value series and the at least one detected sensor state value series are each a Kalman filter state value series.

This means that the state values detected and measured by the at least one measurand sensor and/or the resulting state values are each processed by a Kalman filter. The Kalman filter optimizes the estimation of these state values through the continuous integration of measurements and model predictions. In this way, measurement noise and uncertainties are reduced, thereby improving the accuracy and reliability of the data.

In a further aspect, it is proposed that the at least one measurand sensor comprises a rotation rate sensor and/or linear acceleration sensor and/or an earth magnetic field sensor and/or a video camera and/or a LIDAR sensor and/or a radar sensor and/or an ultrasonic sensor and/or a slope sensor and/or a Correvit sensor and/or a GNSS antenna.

The enumeration is only exemplary for the measurand sensors relevant for the pose calculation of the vehicle and is therefore not to be understood as limiting.

In a further aspect, it is proposed that the at least one historical sensor state value series and/or the at least one detected sensor state value series comprises at least one linear velocity and/or at least one linear acceleration and/or at least one slope angle and/or at least one angular velocity and/or at least one angular acceleration.

Driving maneuvers that are particularly suitable for parameter optimization or parameter calibration of the measurand sensor thus preferably have the measured parameters enumerated above, which are detectable by the at least one measurand sensor. These measurands preferably exhibit large variances of the status value series of the Kalman filter and sensor measurands, and can thus be particularly suitable for the calibration. Further measurands for the vehicle that have a large variance in the state value series are also contemplated, so that the list is to be understood as not limiting.

In a further aspect, it is proposed that the vehicle sensor parameter to be calibrated has an installation position and/or orientation and/or sensor offset.

The stated parameters to be calibrated are not limiting and are merely to be understood as exemplary. Other parameters are contemplated as well. Furthermore, multiple parameters can also be calibrated in parallel or sequentially.

In a further aspect, it is proposed that the storage medium comprises a ring buffer.

A ring buffer, also referred to as ring memory or cyclical buffer, is preferably a data structure for storing a number of elements in a circular manner. This structure is characterized by its fixed, pre-defined size, which remains unchanged after initialization, making it particularly efficient with respect to memory management. The ring buffer preferably uses two hands or indices: a writing pointer pointing to the position at which the next element is stored and a reading pointer pointing to the position from which the next element is read.

The ring buffer demonstrates a cyclic behavior. When the writing pointer reaches the end of the buffer, it returns to the beginning and overwrites the oldest data if not already read. The same principle applies to the reading pointer. The ring buffer works according to the FIFO principle (First In, First Out), which means that the data is processed in the order in which it was received.

In a further aspect, it is proposed that the calibration comprises a simulation of calculations of a Kalman filter for the parameter of the vehicle sensor to be calibrated by varying the parameter of the vehicle sensor to be calibrated so that the probability function, in particular the marginal likelihood function, is maximized.

For parameter optimization or parameter calibration, the driving maneuvers from the past and the most recently detected driving maneuvers, particularly in the parked vehicle, can be considered as follows. Using the recorded sensor measurands, the Kalman filter calculations are simulated. In the simulation, the at least one parameter to be calibrated, for example a sensor orientation, is varied so that the marginal likelihood function (1):

$${ℓ}_{k} = {ℓ}_{k - 1} - \frac{1}{2} ( {y}_{k}^{T} {S}_{k}^{- 1} {y}_{k} + log \vert {S}_{k} \vert + {d}_{y} log 2 π ) \qquad ( 1 )$$

is maximized, wherein [dy] represents the number of measurands [zk] and [yk] which can be calculated as a deviation of the measurands [zk] from the expected measurands from the observation matrix [Hk] and the Kalman filter state [xk]. The covariance [Sk] can be calculated from the covariance matrix [Rk] of the measurement noise, the observation matrix [Hk], and the covariance matrix [Pk] of errors of the Kalman filter state [xk].

In a further aspect, a control unit is also disclosed which is comprised in a vehicle having an autonomous driving function and/or a robotic system and/or an industrial machine, and on which the present method is executable in one of its aspects.

In a further aspect, a computer program comprising program code is disclosed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible designs, refinements and implementations of the disclosure also include combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

The FIGURE shows:

FIG. 1 a schematic flowchart of an exemplary embodiment of the present method;

In the drawing FIGURE, identical reference numbers denote identical or functionally identical elements, parts or components, unless stated otherwise.

### DETAILED DESCRIPTION

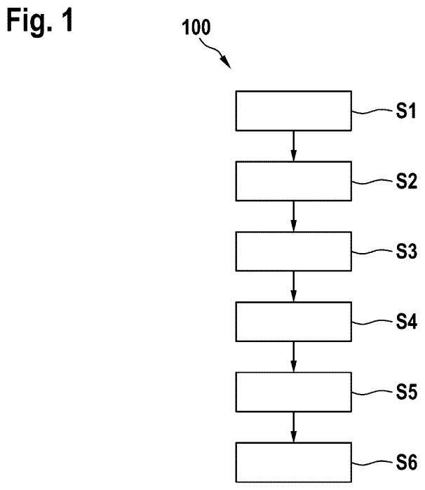

FIG. 1 shows a schematic flowchart of a method for calibrating a parameter of a measurand sensor of a vehicle.

The method can be carried out in any embodiment, at least in part, by an apparatus 100 which may comprise several components not shown in detail, for example one or more provision devices and/or at least one evaluation-and-calculation unit. It is understood that the provision device may be configured so as together with the evaluation-and-calculation unit or may be different from it. Furthermore, the device 100, which may be part of a system, may comprise a storage device and/or an output device and/or a display device and/or an input device.

The computer-implemented method comprises at least the following steps:

In a step S1, there is a provision of at least one historical sensor state value series with an associated variance in a storage medium in relation to at least one historical driving maneuver of the vehicle.

In a step S2, there is a reading of at least one sensor state value series detected by the at least one measurand sensor regarding a driving maneuver of the vehicle; Reading the sensor state value series may be preceded by detecting the sensor state value series by way of the at least one measurand sensor.

In a step S3, there is calculation of a variance from the at least one detected sensor state value series.

In a step S4, there is a comparison of the variance of the at least one historical sensor state value series to the calculated variance of the at least one detected sensor state value series.

In a step S5, there is an overwriting of the at least one historical sensor state value series with the detected sensor state value series when the variance of the detected sensor state value series is greater than the variance of the at least one historical sensor state value series.

In a step S6, there is a calibration of the parameter of the measurand sensor by maximizing a probability function, in particular a marginal likelihood function, based at least on the detected sensor state value series overwriting the historical sensor state value series.

What is claimed is:

1. A method for calibrating a parameter of a measurand sensor of a vehicle, comprising:
providing at least one historical sensor state value series with an associated variance in a storage medium in relation to at least one historical driving maneuver of the vehicle;
reading at least one sensor state value series detected by the at least one measurand sensor regarding a driving maneuver of the vehicle;
calculating a variance from the at least one detected sensor state value series;
comparing the variance of the at least one historical sensor state value series to the calculated variance of the at least one detected sensor state value series;
overwriting the at least one historical sensor state value series with the detected sensor state value series when the variance of the detected sensor state value series is greater than the variance of the at least one historical sensor state value series; and
calibrating the parameter of the measurand sensor by maximizing a probability function based at least on the detected sensor state value series overwriting the historical sensor state value series.

2. The method according to claim 1, wherein the at least one historical sensor state value series and the at least one detected sensor state value series demonstrate a Kalman filter state value series.

3. The method according to claim 1, wherein the at least one measurand sensor comprises a rotation rate sensor and/or linear acceleration sensor and/or an earth magnetic field sensor and/or a video camera and/or a LIDAR sensor and/or a radar sensor and/or an ultrasonic sensor and/or a slope sensor and/or a Correvit sensor and/or a GNSS antenna.

4. The method according to claim 1, wherein the at least one historical sensor state value series and/or the at least one detected sensor state value series comprises at least one linear velocity and/or at least one linear acceleration and/or at least one slope angle and/or at least one angular velocity and/or at least one angular acceleration.

5. The method according to claim 1, wherein the parameter of the measurand sensor to be calibrated comprises an installation position and/or an installation orientation and/or a sensor offset.

6. The method according to claim 1, wherein the storage medium comprises a ring buffer.

7. The method according to claim 1, wherein the calibration comprises a simulation of calculations of a Kalman filter for the parameter of the measurand sensor to be calibrated by varying the parameter of the measurand sensor to be calibrated so that the probability function is maximized.

8. A computer program having program code to execute at least portions of the method according to claim 1 when the computer program is executed on a computer.

9. A computer-readable data carrier having program code of a computer program to execute at least portions of the method according to claim 1 when the computer program is executed on a computer.

10. An apparatus for calibrating a parameter of a measurand sensor of a vehicle, wherein the apparatus comprises a storage medium, at least one measurand sensor, and at least one evaluation-and-calculation device, wherein:
the storage medium is configured to provide at least one historical sensor state value series with an associated variance in relation to at least one historic driving maneuver of the vehicle,
the at least one measurand sensor is configured to detect at least one sensor state value series regarding a travel maneuver of the vehicle, and
the evaluation-and-calculation device is configured to calculate a variance to the at least one detected sensor state value series, compare the variance of the at least one historical sensor state value series to the calculated variance of the at least one detected sensor state value series, and overwrite the at least one historical sensor state value series with the detected sensor state value series in the storage medium when the variance of the detected sensor state value series is greater than the variance of the at least one historical sensor state value series, and to calibrate the parameter of the measurand sensor by maximizing a probability function at least on the basis of the detected sensor state value series overwriting the historical sensor state value series.

11. The method according to claim 1, wherein the probability function is a marginal likelihood function.

12. The method according to claim 11, wherein the calibration comprises a simulation of calculations of a Kalman filter for the parameter of the measurand sensor to be calibrated by varying the parameter of the measurand sensor to be calibrated so that the marginal likelihood function is maximized.

13. The apparatus according to claim 10, wherein the probability function is a marginal likelihood function.
